(19) United States
(12) Patent Application Publication
(10) Pub. No.: US 2013/0026780 A1
(43) Pub. Date: Jan. 31, 2013

(54) Roof Attachment Apparatus for A-Frame Style Trailers

(71) Applicant: Christopher Haldor Hanson, Albany, OR (US)

(72) Inventor: Christopher Haldor Hanson, Albany, OR (US)

(21) Appl. No.: 13/557,434

(22) Filed: Jul. 25, 2012

Related U.S. Application Data
(60) Provisional application No. 61/572,878, filed on Jul. 25, 2011.

(51) Int. Cl. B60J 7/12

(52) U.S. Cl. 296/121

(57) ABSTRACT

The present invention is a roof attachment means for an A-Frame style trailer which has two roofs that fold atop one another when the A-Frame trailer is not in use. The two roofs raise to create a peak for use. There are securing straps attached to the outer front corners of the front roof and along the top outer edged of the rear roof such that as the roofs are being raised by the operator the securing straps maintain the relationship between the front and rear roofs by an elastic component of the securing straps which provides tension and a fixed length component of the securing straps does not allow the roofs to extend beyond the peak of the A-Frame trailer.

### FIELD OF THE INVENTION

The present invention relates generally to A-Frame style folding camping trailers, and more specifically to roof attachment and securing means for A-Frame style folding camping trailers.

### BACKGROUND OF THE INVENTION

The A-Frame trailer, also known as a camping trailer or folding trailer has two roof sections pivot from opposing outside edges of the camping trailer and extend upward creating an A-frame roof atop a trailer base. When retracted or folded, the roof sections fold one on the other creating a flat top surface above the trailer base for streamlined travel and compact storing. There are several brands of A-Frame trailers currently on the market such as Chalet, Aliner, and Columbia Northwest.

Historically, the two roof sections have been secured with a pair of “bungee” cords or the like when in the extended of A-frame configuration. The design flaw in this concept is that the bungee cords stretch and are not strong enough to withstand the forces of wind. Also, over time and weather exposure the bungee cords stretch significantly and lose strength. This makes the two roof sections vulnerable to high winds when raising and lowering. This has been a significant problem for owners and operators of the A-Frame style camping trailer. For example, while extending or retracting the roof sections, a gust of wind may catch either roof section, breaking one or both of the bungees, and fall away from the trailer thereby damaging the roof section, the operator, or both.

Over the past 20 years various methods have attempted to solve this problem, but none have solved the problem in a reliable, cost-effective manner. One such attempt employs a coiled strap similar to a seat belt attached in similar locations as the commonly used bungee cords.

Although this product protects the roofs in their full range of motion and in the setup position, it is bulky, heavy, likely creates added friction during the opening process, and adds significant cost to the A-Frame trailer that is popular for its light weight and low cost.

There is a need for a reliable, simple, easy to use, cost-effective solution to securing the roof sections of A-Frame camping trailers that does not detract from the streamlined nature of the A-Frame camping trailers.

### SUMMARY OF THE INVENTION

The present invention is a roof attachment and securing means for A-Frame style trailers which has two roofs that fold atop one another when the A-Frame trailer is not in use. The two roofs are pivotally attached to opposing outer top edges of the trailer base and raise to create a peaked roof for use. There are securing straps attached to the outer front corners of the front roof and along the top outer edged of the rear roof such that as the roofs are being raised by the operator the securing straps maintain the relationship between the front and rear roofs by an elastic component of the securing straps which provide tension and a fixed length component of the securing straps which does not allow the roofs to extend beyond the peak of the A-Frame roof of the trailer.

### BRIEF DESCRIPTION OF THE DRAWINGS

The above description and other objects, advantages, and features of the present invention will be more fully understood and appreciated by reference to the specification and accompanying drawings, wherein:

FIG. 1 is a side view of an extended A-Frame Trailer depicting the placement of one of the securing straps of the present invention.

FIG. 2 is a side view of an A-Frame Trailer depicting the two roof sections in a partially closed position.

FIG. 3 is a perspective view of an A-Frame Trailer depicting the placement of the securing straps of the present invention as the roof sections are lowered toward the closed position.

FIG. 3a is a sectional view A of FIG. 3 detailing the attachment of one of the securing strap of the present invention on the front and rear roof sections of an A-Frame Trailer.

FIG. 4 is a perspective view of an A-Frame Trailer in the closed position depicting the placement of the upper attachment points of the securing straps of the present invention.

FIG. 5a-5c depict the preferred embodiment as well as two alternate embodiments of the securing straps of the present invention.

### DRAWING ELEMENT NUMBERS

100 A-Frame Trailer

102 Front Roof

104 Rear Roof

106 Right Securing Strap

108 Folding Panel

110 Door

302 Upper Right Attachment

303 Upper Left Attachment

304 Lower Right Attachment

305 Lower Left Attachment

306 Left Securing Strap

310 Right Guide Track

311 Left Guide Track

312 Right Guide

313 Left Guide

502 Elastic Material

504 Alternate Elastic Material

506 Second Alternate Elastic material

508 Cable

### DETAILED DISCUSSION OF THE PREFERRED EMBODIMENTS

Referring to the figures, like elements retain their indicators throughout the several views.

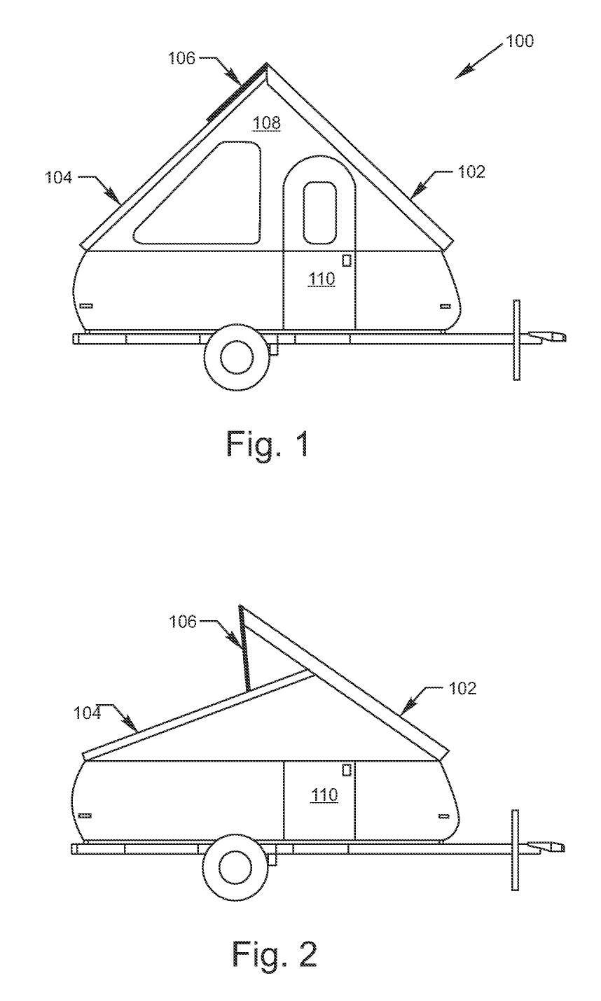

FIG. 1 is a side view of extended A-Frame Trailer 100 depicting placement of Right Securing Strap 106 of the present invention with A-Frame Trailer 100 in the open or extended position. As with most folding A-Frame Trailers, Folding Panel 108 automatically rises from the interior of A-Frame Trailer 100 during the extending process erecting and exposing all of Door 110 for entrance to A-Frame Trailer 100 by the operator.

As shown in FIG. 1, Right Securing Strap 106 is securely attached at one end to Front Roof 102 and at a second end to Rear Roof 104. In the preferred embodiment, Right Securing Strap 106 and Left Securing Strap 306 (not shown) are composed of a fixed length of essentially inelastic, tubular strapping material or webbing coupled with an elastic piece similar to a bungee cord (not shown) disposed within Right Securing Strap 106. The length of Right Securing Strap 106 is such that when in the open position even in high winds, Rear Roof 104 and Front Roof 102 cannot separate outward.

FIG. 2 is a side view of A-Frame Trailer 100 in a partially closed position where Rear Roof 104 is collapsing under Front Roof 102. Right Securing Strap 106 and Left Securing Strap 306 (not shown) assist in the closing operation by the internal elasticity of the straps pulling the two roof sections toward one another while the fixed lengths of Right Securing Strap 106 and Left Securing Strap 306 (not shown) maintain the closing path with little or no opportunity for wind to catch either Front Roof 102 or Rear Roof 104 causing the previously experienced equipment or operator damage.

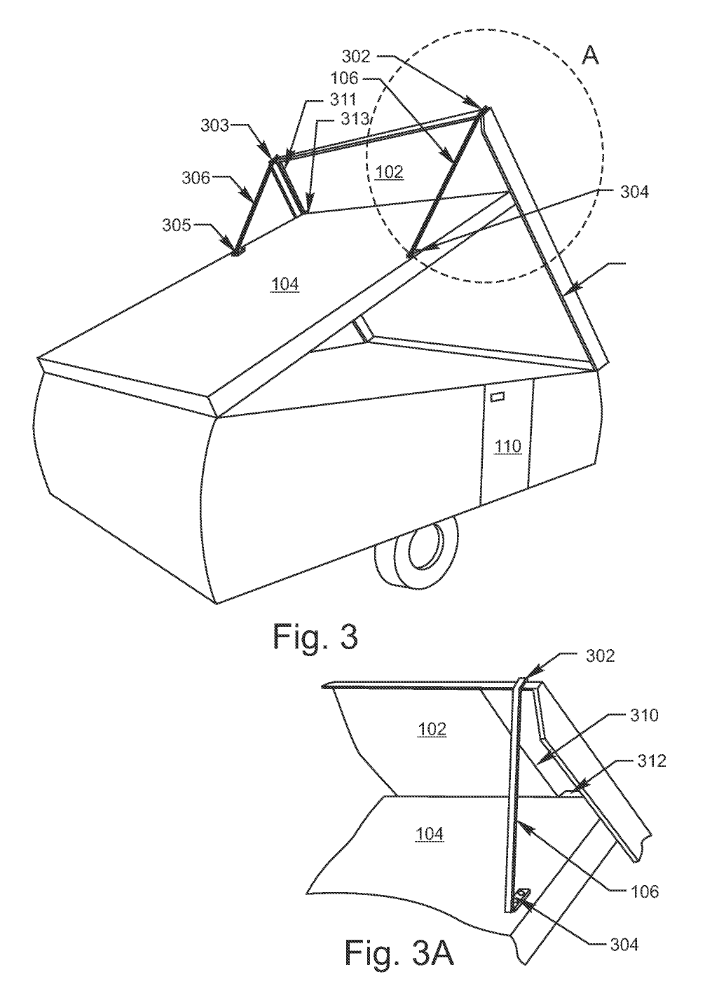

FIG. 3 is a perspective view of A-Frame Trailer 100 illustrating the placement of Right

Securing Strap 106 and Left Securing Strap 306 of the present invention as Front Roof 102 folds over Rear Roof 104 as A-Frame Trailer 100 is closing. Right Securing Strap 106 is attached to Front Roof 102 at Upper Right Attachment 302 and attached to Rear Roof 104 at Lower Right Attachment 304. Left Securing Strap 306 is attached to Front Roof 102 at Upper Left Attachment 303 and attached to Rear Roof 104 at Lower Left Attachment 305.

As A-Frame Trailer 100 is available in varying sizes, the Length of Right Securing Strap 106 and Left Securing Strap 306 will vary as will the placement of Lower Right Attachment 304 and Lower Left Attachment 305. Preferably, as shown in FIG. 3, Lower Right Attachment 304 and Lower Left Attachment 305 are placed a distance approximately one-third of the length of Rear Roof 104 from the front edge.

In the preferred embodiment, Rear Roof 104 has Left Guide 313 on the upper left corner and Right Guide 312 (not shown) on the upper left corner which travel along Left Guide Track 311 and Right Guide Track 312 (not shown), respectively, maintaining the path of closure and rigidity of the system during both the opening and closing operation.

FIG. 3a is sectional view A of FIG. 3 detailing the attachment of Right Securing Strap 106 of the present invention on Front Roof 102 and Rear Roof 104. Right Securing Strap 106 wraps over the front edge of Front Roof 102 and is attached at a first end on the top surface of Front Roof 102 at Upper Right Attachment 302 located proximate a front corner of Front Roof 102. The second end of Right Securing Strap 106 is attached to the top surface of Rear Roof 104 at Lower Right Attachment 304 such that when in the completely closed position, Right Securing Strap 106 is extended to its fixed length with the elastic component of Right Securing Strap 106 under tension with the roof latched closed. Lower Right Attachment 304 is attached to Rear

Roof 104 with screws, bolts, or the like. Similarly, Upper Right Attachment 302 is attached to the top surface of Front Roof 102 with screws, bolts, or the like (not shown). When Front Roof 102 is released, the elasticity of Right Securing Strap 106 and Left Securing Strap 306 assist in raising or opening A-Frame Trailer 100. As one skilled in the art can appreciate, due to the elastic properties of the securing straps, during the initial lifting and opening process the operator will be assisted by the elasticity of the securing straps. Additionally, prior to complete opening Right Securing Strap 106 along with Left Securing Strap 306 (not shown) will reach an elastic neutral position prior to the fully open position where a small amount of force will be required to raise Front Roof 102 and Rear Roof 104 to the fully open position. With the two roofs fully open and latched, Right Securing Strap 106 and Left Securing Strap 306 are again under elastic tension while the two roof sections are held together securely as the fixed lengths of Right Securing Strap 106 and Left Securing Strap 306 are reached thereby limiting any additional upward travel of Front Roof 102 and Rear Roof 104.

Right Guide 312 is located approximate the upper right corner of Rear Roof 104 and travels along Right Guide Track 310 located along the outer edge on the underside of Front Roof 102 during the opening and closing operations. Similarly, Left Guide 313 (not shown) located approximate the left front edge of Rear Roof 104 travels along Left Guide Track 311(not shown). The right and left guides and guide tracks maintain smooth, even travel of Rear Roof 104 under Front Roof 102 during the opening and closing of A-Frame Trailer 100.

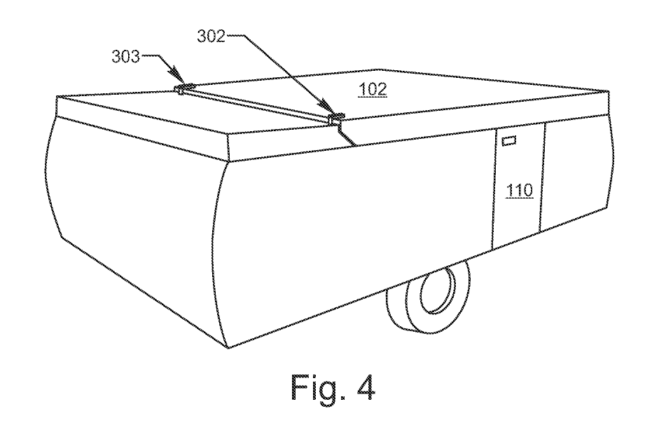

FIG. 4 is a perspective view of A-Frame Trailer 100 in the closed position depicting the placement of Upper Right Attachment 302 of Right Securing Strap 106 and Upper Left Attachment 303 of Left Securing Strap 306 of the present invention. With A-Frame Trailer 100 in the closed position, Upper Right Attachment 302 and Upper Left Attachment 303 are exposed with only a minimal portion of Right Securing Strap 106 and Left Securing Strap 306 exposed thereby protecting Right Securing Strap 106 and Left Securing Strap 306 from the weather and sight.

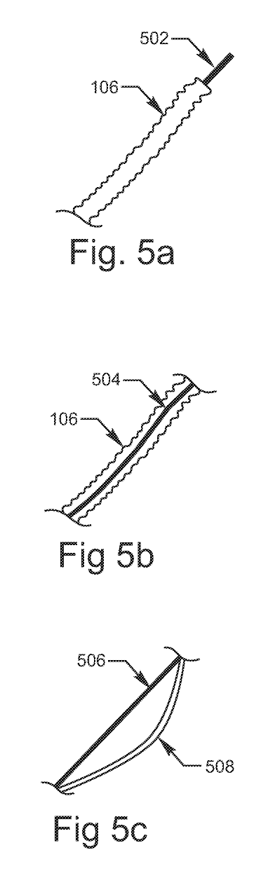

FIG. 5a depicts the preferred embodiment of securing straps of the present invention. As shown, similar to Left Securing Strap 306 (not shown), Right Securing Strap 106 is a section of tubular webbing with Elastic Material 502 disposed within the tubular webbing. In the preferred embodiment, Elastic Material 502 is a length of bungee-type cord that is secured along with Right Securing Strap 106 at Upper Right Attachment 302 and Lower Right Attachment 304. Right Securing Strap 106 is of a length allowing Front Roof 102 and Rear Roof 104 to reach the open position while restricting the opening motion from going beyond the desired peak position.

FIG. 5b depicts an alternate embodiment of Right Securing Strap 106 where Alternate Elastic Material 504 is attached along the length of Right Securing Strap 106. Again Right Securing Strap 106 when fully extended is of a length that limits the travel of Front Roof 102 with respect to Rear Roof 104. Left Securing Strap 306 (not shown) would be of a matching configuration.

FIG. 5c depicts another alternate embodiment of the securing straps of the present invention where both right and left securing straps are a combination of Second Alternate Elastic Material 506 maintaining the tension in the securing strap while Cable 508 limits the travel of Front Roof 102 with respect to Rear Roof 104. In this embodiment, Second Alternate Elastic Material 506 is a bungee cord similar to Elastic Material 502. However, is has been contemplated that a length of rubber, commercial elastic or the like may be used as well. Cable 508 can be a length of flexible plastic enclosed metal cable or any material that will maintain its length.

Wherein the terms and expressions which have been employed in the foregoing specification are used therein as terms of description and not of limitation, there is no intention, in the use of such terms and expressions, of excluding equivalents of the features shown and described or portions thereof, it being recognized that the scope of the invention is defined and limited only by the claims which follow.

I claim:

1. A Roof Attachment apparatus for an A-Frame Trailer having a front roof pivotally attached to an outer edge of the A-Frame Trailer, a rear roof pivotally attached to an opposing outer edge of the A-Frame Trailer, the rear roof folds atop the front roof when the A-Frame Trailer is in a closed position, the front roof and rear roof pivot upward to create a peak when in an open position, comprising:
a first securing strap having a first fixed length component and a first elastic component, said first securing strap is fixedly attached at a first corner of a front edge of the front roof at a first end and fixedly attached to a top surface along a side edge of the rear roof at a second end, and;
a second securing strap having a second fixed length component and a second elastic component, said second securing strap is fixedly attached at a second corner of said front edge of the front roof opposite said first corner at a next first end and fixedly attached to said top surface of the rear an opposing side edge of the rear roof;
wherein, as the front roof and the rear roof are raised creating the peak, said first securing strap and said second securing strap secure contact between the front roof and the rear roof with said first elastic component and said second elastic component create elastic tension and said first fixed length component and said second fixed length component limit extension of said first securing strap and said second securing strap such that the front roof and the rear roof cannot pivot beyond the peak.

2. The Roof Attachments apparatus of claim 1, wherein said first fixed length component is constructed from a length of tubular webbing having said first elastic component constructed from a length of bungee cord disposed within said length of tubular webbing, and said second fixed length component is constructed from a second length of tubular webbing having said second elastic component constructed from a second length of bungee cord disposed within said second length of tubular webbing.

3. The Roof Attachment apparatus of claim 1, wherein said first fixed length component is constructed from a length of strap webbing having said first elastic component is constructed from a length of elastic material attached along said length of strap webbing, and said second fixed length component is constructed from a second length of strap webbing having said second elastic component constructed from a second length of elastic material attached along said second length of strap webbing.

4. The Roof Attachment apparatus of claim 1, wherein said first fixed length component is constructed from a length of cable, said first elastic component is a first length of bungee cord, said second fixed length component is constructed from a length of cable, and said second elastic component is a second length of bungee cord.

5. A Roof Attachment apparatus for an A-Frame Trailer having a front roof pivotally attached to an outer edge of the A-Frame Trailer, a rear roof pivotally attached to an opposing outer edge of the A-Frame Trailer, the rear roof folds atop the front roof when the A-Frame Trailer is in a closed position, the front roof and rear roof pivot upward to create a peak when in an open position, comprising:
a pair of securing straps each having a first fixed length component and a first elastic component, said securing straps are fixedly attached to a first front corner and an opposing second front corner of the front roof at a first end and fixedly attached to a top surface along a first side edge and an opposing second side edge of the rear roof at a second end such that said pair of securing straps are parallel to one another and on opposite sides of the A-Frame Trailer;
wherein, as the front roof and the rear roof are raised creating the peak, said pair of securing straps secure contact between the front roof and the rear roof with said elastic component of each of said pair of securing straps applying elastic tension between the front roof and the rear roof, and said fixed length component of each of said pair of securing straps limits extension of said pair of securing straps such that the front roof and the rear roof cannot pivot outward beyond the peak.

6. The Roof Attachments apparatus of claim 5, wherein said fixed length component of each of said pair of securing straps is constructed from a length of tubular webbing, and said elastic component of each of said pair of securing straps is constructed from a length of bungee cord disposed within said length of tubular webbing.

7. The Roof Attachment apparatus of claim 5, wherein said fixed length component of each of said pair of securing straps is constructed from a length of strap webbing, and said elastic component of each of said securing straps is constructed from a length of elastic material attached along said length of strap webbing of each of said securing straps.

8. The Roof Attachment apparatus of claim 6, wherein said fixed length component of each of said pair of securing straps is constructed from a length of cable, and said first elastic component of each of said pair of securing straps is a length of bungee cord.
